(19) United States
(12) Patent Application Publication
(10) Pub. No.: US 2021/0084057 A1
(43) Pub. Date: Mar. 18, 2021

(54) SYSTEM AND METHOD FOR A VENDOR RISK MANAGEMENT PLATFORM

(71) Applicant: BANK OF MONTREAL, Toronto (CA)

(72) Inventor: Rajneesh CHHABRA, Oakville (CA)

(73) Assignees: BANK OF MONTREAL, Toronto, ON (CA); BANK OF MONTREAL, Toronto, ON (CA)

(21) Appl. No.: 16/620,443

(22) PCT Filed: Jun. 6, 2018
(86) PCT No.: PCT/CA2018/050681

§ 371 Date: Dec. 6, 2019

Related U.S. Application Data
(60) Provisional application No. 62/516,239, filed on Jun. 7, 2017.

(51) Int. Cl. H04L 29/06; G06N 20/00; H04L 9/32

(52) U.S. Cl. CPC H04L 63/1416; H04L 9/3213; H04L 63/1433; G06N 20/00

(57) ABSTRACT

A risk management platform may have a risk management server and a client portal. The client portal can be configured to: receive security data relating to a client system; anonymize the security data; and transmit the security data to the risk management server along with a unique key linked the client system. The security data the risk management server can be configured to: identify the client system using the unique key; generate a score as a security assessment of the client system using a plurality of rules to evaluate the security data; detect a security threat relevant to the client system by processing real-time data feeds; generate an alert for the security threat to the client system; monitor the client portal for a response to the alert by the client system; and update the score in response to the alert or the response.

### CROSS-REFERENCE TO RELATED APPLICATION

This application claims the benefit of U.S. provisional patent application No. 62/516,239 filed on Jun. 7, 2017, the entire content of which is herein incorporated by reference.

### FIELD

Embodiments generally relate to the field of security management, and in particular to security management of external computer systems.

### INTRODUCTION

Organizations exchange sensitive information with third party systems. It may not be clear to a company or organization whether an external system may be trusted with sensitive information. There is a need to assess and manage security risks associated with third party systems.

### SUMMARY

In accordance with one aspect, a non-transitory computer readable medium is disclosed. The medium may store computer-readable instructions that when executed by a computer processor, causes the computer processor to perform: receiving electronic signals representing security data relating to a client system; generating a score representing a security assessment of the client system using a plurality of rules to evaluate the security data; detecting a security threat relevant to the client system by processing real-time or near real-time data feeds; generating an alert for the security threat to the client system; transmitting the alert to a client portal identifying the security threat to the client system; monitoring the client portal for a response to the alert by the client system; and updating the score based on at least one of the alert and the response from the client portal.

In some embodiments, the instructions further causes the computer processor to perform: dynamically updating an interface at the client portal to display the score, the alert, and the updated score.

In some embodiments, the instructions further causes the computer processor to perform: determining a plurality of sub-scores and assigning a weight to each of the plurality of sub-scores.

In some embodiments, the instructions further causes the computer processor to perform: processing the security data and determining a plurality of keywords based on the security data; for each of the plurality of keywords, determining one or more parameters applicable to the keyword; searching the security data for a value for each of the one or more parameters; and generating the score based at least in part on the value for each of the one or more parameters.

In some embodiments, one keyword of the plurality of the keywords comprises a password, and the one or more parameters applicable to the keyword comprise at least one of: length, capital, letter, number, and character.

In some embodiments, the value for each of the one or more parameters applicable to the keyword comprises a numerical value or an alphabetic.

In some embodiments, updating the score may include processing a plurality of criteria associated with the response from the client portal.

In some embodiments, the plurality of criteria include a response time and a type of action taken by the client system in response to the alert.

In some embodiments, the type of action may include at least one of: network discovery, penetration test, vulnerability test, hardware update, and software update.

In some embodiments, the instructions further causes the computer processor to perform: determining when to engage the client system for a contract based on the score and the security data.

In some embodiments, the instructions further causes the computer processor to perform: determining at least one of: a length of the contract, type of products contracted with the client system, type of service contracted with the client system, level of cleared security granted to the client system, and one or more staff of the client system engaged to carry out terms of the contract.

In some embodiments, the instructions further causes the computer processor to perform: generating one or more recommendations regarding one or more security system settings to the client system based on the security data.

In some embodiments, the instructions further causes the computer processor to perform: receiving the security data as one or more bulk files.

In some embodiments, the instructions further causes the computer processor to perform: generating and causing to display at the client portal, one or more questions dynamically for the client system; processing responses to the one or more questions received from the client portal; and determining additional security data based on the responses to the one or more questions.

In some embodiments, the instructions further causes the computer processor to apply machine learning techniques to: extract the plurality of keywords based on the anonymized security data; determine the one or more parameters applicable to the plurality of keywords and the value for each of the one or more parameters.

In some embodiments, the instructions further causes the computer processor to use the machine learning techniques to perform text analysis.

In some embodiments, the instructions further causes the computer processor to use the machine learning techniques to perform natural language processing.

In accordance with one aspect, there is provided a risk management platform comprising a risk management server and a client portal. The client portal can be configured to: receive electronic signals representing security data relating to a client system; anonymize the security data; and transmit the anonymized security data and a unique key linked to the client system to the risk management server.

The risk management server can be configured to: identify the client system using the unique key; generate a score representing a security assessment of the client system using a plurality of rules to evaluate the anonymized security data; detect a security threat relevant to the client system by processing real-time or near real-time data feeds; generate an alert for the security threat to the client system; transmit the alert to the client portal identifying the security threat to the client system; monitor the client portal for a response to the alert by the client system; and update the score based on at least one of the alert and the response from the client portal.

In some embodiments, the risk management server can dynamically update an interface at the client portal to display the score, the alert, and the updated score in response to a control command received at the risk management server.

In some embodiments, generating the score includes determining a plurality of sub-scores and assigning a weight to each of the plurality of sub-scores.

In some embodiments, generating the score includes: processing the anonymized security data and determining a plurality of keywords based on the anonymized security data; for each of the plurality of keywords, determining one or more parameters applicable to the keyword; searching the anonymized security data for a value for each of the one or more parameters; and generating the score based at least in part on the value for each of the one or more parameters.

In some embodiments, one keyword of the plurality of the keywords comprises the word “password”, and the one or more parameters applicable to the keyword comprise at least one of: length, capital, letter, number, and character.

In some embodiments, the value for each of the one or more parameters applicable to the keyword includes a numerical value or an alphabetic.

In some embodiments, updating the score comprises processing a plurality of criteria associated with the response from the client portal.

In some embodiments, the plurality of criteria include a response time and type of action taken by the client system in response to the alert.

In some embodiments, the type of action includes at least one of: network discovery, penetration test, vulnerability test, hardware update, and software update.

In some embodiments, the risk management server is configured to determine when to engage the client system for a contract based on the score and the anonymized security data.

In some embodiments, the risk management server is configured to determine at least one of: a length of the contract, type of products contracted with the client system, type of service contracted with the client system, level of cleared security granted to the client system, and one or more staff of the client system engaged to carry out terms of the contract.

In some embodiments, the risk management server is configured to generate one or more recommendations regarding one or more security system settings to the client system based on the anonymized security data.

In some embodiments, the security data is received by the risk management server as one or more bulk files.

In some embodiments, the risk management server is configured to: generate and cause to display at the client portal, one or more questions dynamically for the client system; process responses to the one or more questions received from the client portal; and determine additional security data based on the responses to the one or more questions.

In some embodiments, the risk management server is configured to apply machine learning techniques to: extract the plurality of keywords based on the anonymized security data; determine the one or more parameters applicable to the plurality of keywords and the value for each of the one or more parameters.

In some embodiments, the risk management server is configured to apply text analysis using the machine learning techniques.

In some embodiments, the risk management server is configured to apply natural language processing using the machine learning techniques.

In accordance with yet another aspect, a risk management server is provided. The server may be configured to: receive electronic signals representing security data relating to a client system; generate a score representing a security assessment of the client system using a plurality of rules to evaluate the security data; detect a security threat relevant to the client system by processing real-time or near real-time data feeds; generate an alert for the security threat to the client system; transmit the alert to a client portal identifying the security threat to the client system; monitor the client portal for a response to the alert by the client system; and update the score based on at least one of the alert and the response from the client portal.

In some embodiments, the risk management server is configured to dynamically update an interface at the client portal to display the score, the alert, and the updated score in response to a control command received at the risk management server.

In some embodiments, generating the score includes determining a plurality of sub-scores and assigning a weight to each of the plurality of sub-scores.

In some embodiments, generating the score includes: processing the security data and determining a plurality of keywords based on the security data; for each of the plurality of keywords, determining one or more parameters applicable to the keyword; searching the security data for a value for each of the one or more parameters; and generating the score based at least in part on the value for each of the one or more parameters.

In some embodiments, one keyword of the plurality of the keywords includes the word “password”, and the one or more parameters applicable to the keyword includes at least one of: length, capital, letter, number, and character.

In some embodiments, the value for each of the one or more parameters applicable to the keyword comprises a numerical value or an alphabetic.

In some embodiments, updating the score includes processing a plurality of criteria associated with the response from the client portal.

In some embodiments, the plurality of criteria include a response time and type of action taken by the client system in response to the alert.

In some embodiments, the type of action includes at least one of: network discovery, penetration test, vulnerability test, hardware update, and software update.

In some embodiments, the risk management server is configured to determine when to engage the client system for a contract based on the score and the security data.

In some embodiments, the risk management server is configured to determine at least one of: a length of the contract, type of products contracted with the client system, type of service contracted with the client system, level of cleared security granted to the client system, and one or more staff of the client system engaged to carry out terms of the contract.

In some embodiments, the risk management server is configured to generate one or more recommendations regarding one or more security system settings to the client system based on the security data.

In some embodiments, the security data is received by the risk management server as one or more bulk files.

In some embodiments, the risk management server is configured to: generate and cause to display at the client portal, one or more questions dynamically for the client system; process responses to the one or more questions received from the client portal; and determine additional security data based on the responses to the one or more questions.

In some embodiments, the risk management server is configured to apply machine learning techniques to: extract the plurality of keywords based on the anonymized security data; determine the one or more parameters applicable to the plurality of keywords and the value for each of the one or more parameters.

In some embodiments, the risk management server is configured to apply text analysis using the machine learning techniques.

In some embodiments, the risk management server is configured to apply natural language processing using the machine learning techniques

In accordance with still another aspect, a computer-network-implemented method for risk management is provided. The method includes: receiving, by a computer processor, electronic signals representing security data relating to a client system; generating, by the computer processor, a score representing a security assessment of the client system using a plurality of rules to evaluate the security data; detecting, by the computer processor, a security threat relevant to the client system by processing real-time or near real-time data feeds; generating, by the computer processor, an alert for the security threat to the client system; transmitting, by the computer processor, the alert to a client portal identifying the security threat to the client system; monitoring, by the computer processor, the client portal for a response to the alert by the client system; and updating, by the computer processor, the score based on at least one of the alert and the response from the client portal.

In some embodiments, the method may include dynamically updating an interface at the client portal to display the score, the alert, and the updated score.

In some embodiments, generating the score includes determining a plurality of sub-scores and assigning a weight to each of the plurality of sub-scores.

In some embodiments, generating the score includes: processing the security data and determining a plurality of keywords based on the security data; for each of the plurality of keywords, determining one or more parameters applicable to the keyword; searching the security data for a value for each of the one or more parameters; and generating the score based at least in part on the value for each of the one or more parameters.

In some embodiments, one keyword of the plurality of the keywords comprises a password, and the one or more parameters applicable to the keyword comprise at least one of: length, capital, letter, number, and character.

In some embodiments, the value for each of the one or more parameters applicable to the keyword comprises a numerical value or an alphabetic.

In some embodiments, updating the score comprises processing a plurality of criteria associated with the response from the client portal.

In some embodiments, the plurality of criteria include a response time and type of action taken by the client system in response to the alert.

In some embodiments, the type of action comprises at least one of: network discovery, penetration test, vulnerability test, hardware update, and software update.

In some embodiments, the method may include: determining when to engage the client system for a contract based on the score and the security data.

In some embodiments, the method may include: determining at least one of: a length of the contract, type of products contracted with the client system, type of service contracted with the client system, level of cleared security granted to the client system, and one or more staff of the client system engaged to carry out terms of the contract.

In some embodiments, the method may include: generating one or more recommendations regarding one or more security system settings to the client system based on the security data.

In some embodiments, the method may include: receiving the security data as one or more bulk files.

In some embodiments, the method may include: generating and causing to display at the client portal, one or more questions dynamically for the client system; processing responses to the one or more questions received from the client portal; and determining additional security data based on the responses to the one or more questions.

In some embodiments, the method may include: applying machine learning techniques to: extract the plurality of keywords based on the anonymized security data; determine the one or more parameters applicable to the plurality of keywords and the value for each of the one or more parameters.

In some embodiments, the method may include: using the machine learning techniques to perform text analysis.

In some embodiments, the method may include: using the machine learning techniques to perform natural language processing.

### DESCRIPTION OF THE FIGURES

Embodiments will now be described, by way of example only, with reference to the attached figures, wherein in the figures:

FIG. 1 is a diagram of an example risk management platform according to some embodiments;

FIG. 2 is a diagram of an example risk management system according to some embodiments;

FIG. 3 is a diagram of an example empty pockets approach for a risk management platform according to some embodiments;

FIG. 4A is an example certification process workflow according to some embodiments;

FIG. 4B is an example monitoring process workflow according to some embodiments;

FIG. 5 is an example process for assessing and updating a security score of a system according to some embodiments;

FIG. 6 is a diagram of an example architecture of risk management platform according to some embodiments;

FIGS. 7A, 7B and 7C show a diagram of an example data model for risk management platform according to some embodiments;

FIG. 8 is a diagram of an example architecture of a risk management server according to some embodiments;

FIGS. 9 to 18 are various views of example interfaces of risk management platform accessible via risk management system portal according to some embodiments; and

FIGS. 19 to 26 are various views of example interfaces of risk management platform accessible via client portal according to some embodiments.

### DETAILED DESCRIPTION

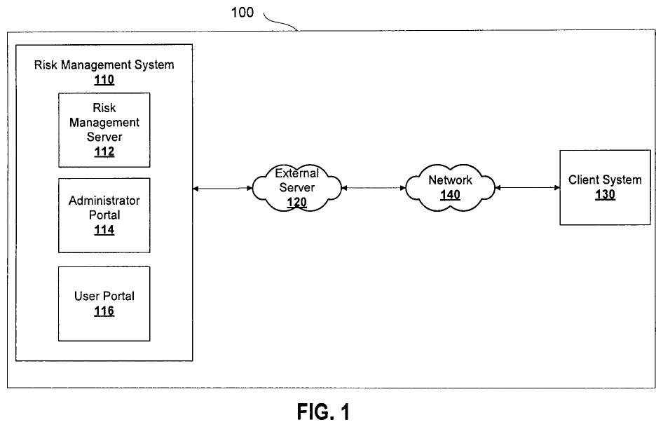

FIG. 1 is a diagram of an example risk management platform 100 according to some embodiments. Risk management platform 100 can assess and manage security risks associated with third party systems, such as client system 130. Risk management platform 100 can provide an initial assessment and ongoing monitoring of information technology security of one or more client systems 130. Risk management platform 100 can perform the assessment and monitoring automatically based on a flexible, dynamic and interactive process. Risk management platform 100 can assign a score to a client system 130 based on an initial assessment and ongoing monitoring of attributes of the client system 130, user input, user assessment, and response of the client system 130 to recommendations, alerts, or communication from risk management platform 100. Risk management platform 100 can associate client system 130 with a security status (e.g. certification-related status) based on the assigned score. Risk management platform 100 can dynamically update the score and status of a client system 300 based on the ongoing assessment and monitoring.

Risk management platform 100 implements a security workflow solution to assess and monitor the security of client system 130. For example, client system 130 can relate to a law firm and can include computing hardware and software used by the law firm. A law firm can handle highly sensitive information and its client system 130 should be secure from cyber-attacks and threats. Risk management platform 100 can identify relevant security threats and notify client system 130. Risk management platform 100 can monitor client system 130 for compliance with ongoing security risks to check whether appropriate action was taken to mitigate identified security threats.

Throughout this disclosure, a law firm may be described as an example for a client system. It is understood that any other company may be an example of a client system or firm.

Cyber-attacks and threats constantly change on a regular basis. Risk management platform 100 can monitor changing security risks to update scores associated with client systems 130. Risk management platform 100 can generate alerts for potential security risks and verify compliance or response by the client system 130 in response to the alerts. Risk management platform 100 can consider the end-to-end flow of data handling procedures by client system 130. Risk management platform 100 can generate a score that represents a security assessment of the client system 130. Risk management platform 100 can generate a score based on a plurality of sub-scores such as technology system score, an assessor score, and a responsive score. Each of the sub-scores may be associated with a respective weight.

Risk management platform 100 can provide ongoing monitoring of one or more attributes of client system 130 relating to its information security and provide communications alerting one or more client systems 130 as to threats that could attach or affect the client system 130.

External server 120 can function as an externally hosted site for interaction with one or more client systems 130. External server 120 can connect with a separate internally hosted site for administrator access such as, for example, risk management server 112. Data transfer between the sites can be encrypted or otherwise secured. This may provide security and data anonymity from unauthorized interception or access of data during transfer or at a client system 130. For example, risk management system 110 can assign a unique token to a particular client system 130 to anonymize client system 130. The link between the unique token and the particular client system 130 can be stored by risk management server 112.

Risk management platform 100 includes a risk management server 112. Risk management system 110, client system 130, and/or external server 120 can be directly coupled and indirectly coupled via the network. Network 140 (or multiple networks) is capable of carrying data and can involve wired connections, wireless connections, or a combination thereof. Network 140 may involve different network communication technologies, standards and protocols.

Client system 130 can include software applications, hardware devices, client portals, servers, data storage, assets, network infrastructure, and so on. Client system 130 can connect to risk management system 110 via network 140. For example, client system 130 can refer to computing components of a particular organization or subset of an organization, such as a region or office of the organization.

Risk management system 110 includes a risk management server 112 that, with respect to the information security of a multiplicity of client systems 130, can control the assessment of a plurality of client systems 130, the ongoing assessment or monitoring of the client systems 130, scoring of the client systems 130, and any alerts, for example, of security threats, transmitted to the client systems 130.

Risk management system 110 includes an administrator portal 114 and a user portal 116. Administrator portal 114 can allow an administrator to engage with risk management system 110 to provide configuration parameters and update one or more scores associated with one or more client systems 130. Administrator portal 114 can override parameters customizable by a user engaged with risk management system 110.

User portal 116 can allow a user to engage with risk management system 110 to customize parameters related to information security scoring, including algorithms, protocols, weighting, processes, and/or questions that can be used in assessing and/or monitoring the security of one or more client systems 130. User portal 116 can allow a user to engage with risk management system 110 to customize parameters related to thresholds against which scores associated with one or more client systems 130 can be measured against, for example, to determine whether remediation, termination, modification, update, and/or patch of a client system 130 or any component or attribute should be recommended.

An administrator or user engaged with risk management system 110 can access or view an audit trail of all activities in the risk management platform 100. For example, the administrator or user can view a graph clustering representation of scoring or view or access reports. Risk management system 110 can have reporting capabilities. Risk management system 110 can implement other program management functionalities.

External server 120 can communicate with risk management system 110 and one or more client systems 130 over one or more encrypted connections. External server 120 can securely transfer (e.g. encrypted) data received from client system 130 to risk management system 110 or risk management server 112. External server 120 can delete or otherwise prevent unauthorized access of data transferred to risk management system 110 or risk management server 112. External server 120 can securely receive (e.g. encrypted) data from one or more client systems 130. In some embodiments, data, for example, forms or documents, received from a user engaged with client system 130 can be encrypted on receipt at client system 130, for example, with a secure key. Client system 130 can then cause the encrypted data to be transmitted to external server 120.

Anonymity of data provided at or by client system 130 to risk management system 110 may protect client system 130 against security threats or data interception. For example, client system 130 may receive messages indicating security threats relating to its computing systems and if intercepted may reveal vulnerabilities that can be exposed if client system 130 is identifiable by the messages. Accordingly, the messages can use a unique token to de-identify and anonymize client system 130. If a message is intercepted the identification of the client system 130 might not be revealed.

Risk management system 110 implements different security tools to facilitate data sharing. As noted, client system 130 can be anonymized using a unique token to prevent identification of the client system 130 by intercepting messages exchanged. Risk management system 110 can receive data from client system 130 for certification. Once the certification is complete the received data can be deleted from risk management system 110. Accordingly, risk management system 110 evaluates and processes data and can then delete the data after it has been processed. Risk management platform 110 can evaluate and process data using machine learning rules. For example, the data may relate to an IT policy for client system 130 and the machine learning rules can process the IT policy as part of an evaluation or certification.

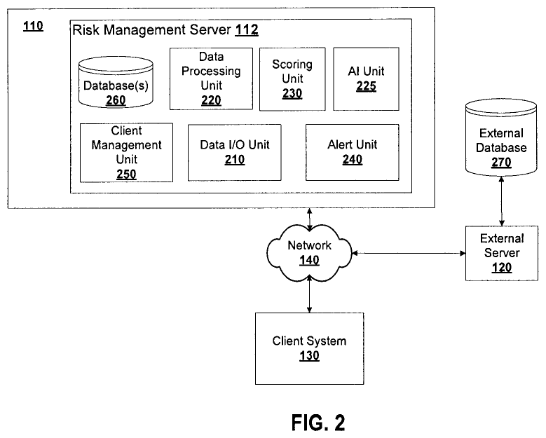

FIG. 2 is a view of an example risk management system 110 and client 130 according to some embodiments. Risk management system 110 includes a risk management server 112. Risk management server 112 can receive and send data over network 140 via data I/O unit 210. Risk management system 110 can process data using data processing unit 220 and generate a score for client system 130 using data scoring unit 230. Risk management system 110 can process data feeds to identify security threats and cause transmission of alerts using alert unit 240. Risk management system 110 can identify one or more client systems 130 that the security threat is relevant to and transmit an alert to those client systems 130. Risk management system 110 can manage and generate data related to one or more client systems 130 using client management unit 250; and store data in and retrieve data from one or more databases 260.

In some embodiments, some or all of the security data can be received by the risk management server 112 as an individual file or one or more bulk files.

In some embodiments, the risk management server 112 may be configured to dynamically generate one or more questions dynamically for a client system 130. The server 112 may process responses to the one or more questions received from the client portal; and determine additional security data based on the responses to the one or more questions.

The one or more questions may be displayed at the client portal 330 for a client system 130 to respond.

In some embodiments, the server 112 may process the security data, which may or may not be anonymized, and determine a plurality of keywords based on the anonymized security data; for each of the plurality of keywords, determine one or more parameters applicable to the keyword; search the security data for a value for each of the one or more parameters; and generate the score based at least in part on the value for each of the one or more parameters.

In some embodiments, risk management server 112 includes an Artificial Intelligence (AI) unit 225 configured to apply machine learning techniques when processing data and generating or updating a score for the client system. For example, AI unit 225 may extract one or more keywords based on security data, which may or may not be anonymized; determine one or more parameters applicable to the plurality of keywords and a value for each of the one or more parameters. AI unit 230 may apply text analysis or natural language processing to find the keywords. For instance, a keyword may be the word “password”, whereas the one or more parameters may be one of: length, capital, letter, number, and character. The corresponding value for each of the parameters may be a numeric value for length, a numeric value for letter to indicate how many letters are required in the password, a numeric value for number to indicate how many numbers are required in the password, and a numeric value for character to indicate how many special characters (e.g. “!” or “$”) are required in the password. The corresponding value may also be an alphabetic value, such as “Y”, “N” “Yes” or “No” to indicate whether a capital, letter, number or character is required. The AI unit 225 may be configured to apply contextual analysis and crawl the security data to look for the keywords, parameters and values in order to determine if the client system in question has a password setting that meets a minimum threshold, and how strong the password setting may be.

For another instance, a keyword in the security data may be the word “firewall”, and the one or more parameters may be at least one of: type, vendor, custom, and layer. A value for the parameter “type” may be “hardware”, “software”, “packet filters”, “stateful inspection” or “proxy”. A value for the parameter “vendor” may be a name of a known vendor for selling firewall equipment and/or services. A value for the parameter “custom” may be YES or NO, or a name for the custom firewall. A value for the parameter “layer” may indicate if the firewall is network layer, application layer, or any other layer.

In some embodiments, AI unit 225 may: (1) assess the security data and any additional documents to extract data to populate the security profile and generate flags for any potential security threat; (2) look for patterns of behaviours during an engagement; and (3) help generate various component scores.

For example, AI unit 225, which may include an AI engine, may read one or more documents and look for various names (outside dictionary items, known firm names in a specified industry, known business names, likely business names), addresses (postal codes, city, states, countries), phone numbers (North American and international phone number patterns, formats), email addresses and so on.

For another example, AI unit 225 may also generate tags based on keywords. In some embodiments, keywords may be determined based on consistency across documents, dictionary rules and grammar, as well as standards and combinations of words.

AI unit 225 may read a document and look for structured (such as password length, password expiration, disabling access after number of failed tries) and unstructured parameters (e.g. USB access, communication of policy, training). Initially unstructured parameters may, in some embodiments, be transmitted to an administrator for decisions and AI unit 225 may study the decisions and draw patterns, thereby generating or updating a decision matrix and learns what an administrator typically looks for in order to make a decision. AI unit 225 may be configured to incorporate past decisions into its rules in order to generate a decision. The structured parameters can have associated metatags to provide contextual data or descriptors or attributes.

Client management unit 250 can create a profile for third parties, for example, client systems 130, by requesting information from the third party. The information can include data regarding the hardware and software systems used by client system 130, IT policies, data handling policies, data retention policies, mobile device policies and so on. The information can also include responses to questions for certification of client system 130. Client management unit 250 can generate an interface with a form and form fields to receive data, for example.

In some embodiments, the client system 130 can connect to risk management system 110 to transmit input data in response to questions for certification. The data processing unit 220 can process and aggregate the data from multiple client systems 130 to generate trends and analytics. The risk management system 110 can process and store the data linked to a unique token corresponding to the client system 130. The risk management system 110 can use the data relating to a client system 130 to generate a score using scoring unit 230.

Risk management system 110 can receive rules or instructions for computation from one or more external servers 120 or external databases 270 via network 140. The rules or instructions may facilitate or direct score generation or data processing. For example, machine learning rules may be used, for example by AI unit 225, to determine or modulate the weighting of data used in computation of one or more scores.

Risk management system 110 can receive data from a user engaged with risk management system 110 via an administrator portal 114 or a user portal 116. The user can specify how one or more scores corresponding to a client system 130 or group of client systems 130 are computed or generated. The user can modify, adjust, change, or select one or more rules, weights or instructions for computation that can apply to facilitate or direct score generation or data processing. An update can trigger a corresponding update to one or more scores. For example, scoring unit 230 may provide the user with a question bank based on customizable parameters (e.g. policy, process, etc.) that the user can provide answers. The risk management server 112 can process the answers or responses for generation or computation of one or more scores. The risk management server 112 can allow the user to increase or decrease weighting based on personal security preferences and concerns. The risk management server 112 can allow the user to add or remove questions or processes. The risk management server 112 can allow the user to set its own scoring protocol or weighting, set security thresholds (e.g. green, yellow, red) for remediation or termination of activity. An administrator may manually override one or more scores generated by scoring unit 230. This enables customization and configuration of the certification and monitoring process.

Scoring unit 230 can generate an overall score for a client system 130 as a function of a system score, assessor score, and responsive or monitoring score. The system score can relate to the overall security of the hardware and software features of a client system 130, which can also include data and information policies. The assessor score can be a discretionary score to enable a user to provide a contextual rating for a client system 130. The responsive score can relate to the ongoing monitoring of client system 130 including compliance and actions taken in response to a security alert. The overall score can be compared to a threshold score to determine whether a client system 130 can be assigned a certification status.

The certification status and the overall score may indicate how secure a firm's system is. As described herein, once assigned a certification, decision can be generated by server 112 with respect to whether to work with the firm, as well as what kind of service or data can be performed or stored by the firm. A length of contract may also be determined. For example, if a score is high, a longer contract length may be recommended. If a score is close to a minimum threshold, a shorter contract may be awarded, allowing for more frequent review(s) prior to renewing or extending the contract.

In some embodiments, scoring and certification status may be based on raw security data. Raw data can include practice areas for a law firm, such that work can be given to the firm.

Recommendations can also be made based on the overall or component score. For example, if a plurality of firms are determined to be low risk, server 112 may perform data crunching to see what settings or action items these firms are currently doing, and make recommendation to other firms based on the settings or action items.

In some embodiments, a system score can have a first weight, a responsive score can have a second weight, and an assessor score can have third weight. Scoring unit 230 can aggregate the system score, the responsive score, and the assessor score to generate an overall score. The first weight can make the system score have a greater or lower impact on the overall score. The second weight can make the responsive score have a greater or lower impact on the overall score. The third weight can make the assessor score have a greater or lower impact on the overall score. Accordingly, the overall score can consider whether a client system 130 has an initial security level as well as ongoing security actions. The overall score is dynamic and constantly changing given the ongoing nature of security threats which in turn trigger required actions by client system 130.

Scoring unit 230 can generate a system score for a client system 130 based on automatically collecting and processing data related to the client system 130 and/or user-provided data. In some embodiments, a client system 130 can be required to meet a minimum threshold system score. If that threshold system score is met, the system score generated for the client system 130 can be assigned a weight for computation of the overall score of the client system 130. The system score can be based on a security-related attributes of the client system 130, for example, related to its firewalls, data storage, data access, applications, and policies.

In some embodiments, for example, a firewall configured at a default setting may be determined to be less secure than a customized firewall by an Internet Service or Internet Security provider. For another example, a client system 130 may have an internal data access policy indicates that an employee or staff cannot send more than five documents outside of company or specify that no portable memory storage device is allowed. A client system may also have a policy specifying manners of transmission of encrypted documents and attachments AI unit 225 may learn the security profile based on one or more responses within the security data. For instance, AI unit 225 can use text processing on policies to receive input or responses to questions; and if there is a security issue with a vendor, the AI unit can adjust the score for any user that uses the vendor and also provides a notification. A recommended course of action such as a penetration test may be identified and recommended to client system 130.

In some embodiments, scoring unit 230 may computer an overall or component score based on a most up-to-date database containing industry best practices. The database may be, for instance, a table listing one or more approved firewall settings, password settings, data encryption policies, and so on. For example, if a client system 130 has a firewall in place and it is of the hardware type, then scoring unit 230 may assign a higher score to the client system than if the client system simply had a software firewall with default settings. A mapping table may be used to map one or more criteria to a component score. Both the database and the mapping table may be updated in real time or near real-time, or from time to time.

Scoring unit 230 can generate an assessor score for a client system 130 based on a discretionary input from a user engaged with risk management system 110 to provide a contextual assessment of the client system 130. In some embodiments, the assessor score generated for the client system 130 can be assigned a weight for computation of the score of the client system 130. The assessor score in some embodiments can be dominant and overwrite other types of components scores. In some embodiments, AI unit 225 can see that a firm has not yet implemented a background check process, and may proceed to ask a firm if it has any plan to implement the background check process. If the firm's response to the question is confirmative (e.g. “yes”), the AI unit 225 may automatically query as to how long the implementation may take, and set a reminder to follow up within a prescribed time limit (e.g.. one to three months) to request proof of action. In this case, a client system 130 that would have otherwise failed the certification status due to lack of a background check process, may be still certified based on the time it takes to implement the background check process.

Scoring unit 230 can generate a responsive score for a client system 130 based on the assessed responsiveness of a client system 130 to notifications by risk management system 110, for example, threat alerts, notifications of patches, or requests for changes to client system 130. For example, the responsive score of a client system 130 can start at a perfect score (e.g., 100/100) and decrease with sub-optimal assessed responsiveness. Responsiveness may be measured by the length of time taken for a client system 130 or associated component is modified or patched in response to security threat and/or the sufficiency with which the security threat is addressed.

For example, if a threat is detected against a security setting, a score may be lowered across firms (e.g. client systems) having the security setting. An alert may be sent to all affected firms, and each firm may get an updated score based on how long it takes to respond, and what each response may be. Early responders may get a higher score than later responders, who may in tern get a higher score than firms who do not respond. If a firm responds with in the stipulated time, it may be given a favourable responsive score. The stipulated time may be provided based on threat level and difficulty level. A firm may perform an action to remove the threat within the time limit, or may be given an extension to do so. In some embodiments, a response of any sort is judged to be a better score than no response at all.

The respective weighting of the system score, assessor score, and responsive score can be determined by scoring unit 230 based on rules, instructions for computation, and/or input of a user engaged with risk management system 110 via administrator portal 114 or user portal 116.

In some embodiments, a responsive score may be determined based on a client system's history of responding to alerts (e.g. a default score of 100 may be lowered if the client system failed to respond once). The responsive score may be worth 40% of the overall score. For a client system without any history, the responsive score may be initially set at 100/100, and may be gradually deducted for any late or missing response.

In some embodiments, updating the score comprises generating or updating a responsive score based on processing a plurality of criteria associated with the response from the client portal. The criteria can include, for example, response time and a type of action taken by the client system in response to the alert. The type of action can include at least one of: network discovery, penetration test, vulnerability test, hardware update, and software update. The responsive score may be used to update the overall score for the client system. The server can then dynamically update an interface at the client portal to display the score, the alert, and the updated score in response to a control command received at the risk management server.

Scoring unit 230 can store one or more scores or score components associated with a client system 130 in one or more databases 260. Scoring unit 230 can control client management unit 250 to create or update a profile associated with the client system 130, and/or cause the scores or score components to be transmitted over one or more networks 140, for example, to an external server 120 or client system 130. Client system 130 may present or indicate a score or score component via a client portal 330.

In some embodiments, the risk management server 112 may determine when to engage the client system 130 for a contract based on the score and the security data. For example, the risk management server 112 may determine at least one of: a length of the contract, type of products contracted with the client system, type of service contracted with the client system, level of cleared security granted to the client system, and one or more staff of the client system engaged to carry out terms of the contract.

In some embodiments, the risk management server 112 may generate one or more recommendations regarding one or more security system settings to the client system based on the anonymized security data. For example, it may generate a recommendation for a client system 130 to install a particular type of firewall as other systems similar to the client system 130 has seen some improvements in security after installing the same type of firewall.

Alert unit 240 can generate one or more alerts or data for transmission to one or more client systems 130 based on security data and data about the client system 130. The security data can be received from one or more security news wires via data I/O unit 210 and/or from storage in one or more databases 260. The data about the client system 130 can be received from client management unit 250, from the client system 130 via data I/O unit 210 over network 140, from storage in one or more databases 260, and/or from a combination of sources. Client management unit 250 can generate, maintain, and update a profile for each client system 130, where such profile can consist of data related to attributes about client system 130. For example, alert unit 240 can generate and send an alert that a certain internet browser has a security flaw exposing connected systems to possible security breaches to each of the client systems 130 that have that internet browser installed on associated computers.

As anonymity of data provided at or by client system 130 to risk management system 110 can help the client system 130 to mitigate vulnerability of receiving messages that identify security threats by data interception. Risk management platform 100 may implement an empty pockets approach (EPA) to data security.

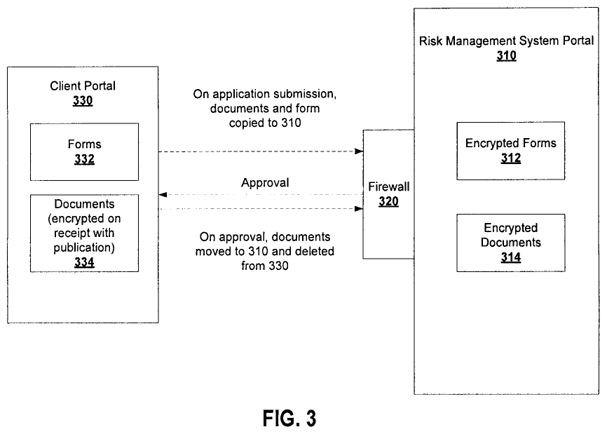

FIG. 3 is a view of an example EPA. There can be three levels of EPA security on a client portal 330 that interfaces with client system 130. At EPA level one, no valuable information is accessible or retrievable on the client portal 330. At EPA level two, there is a minimum level of valuable information accessible or retrievable on the client portal 330. At EPA level three, there is a constant exchange of information between client portal 330 and a perimeter network or demilitarized zone (DMZ).

In some embodiments, portal 310 and/or server 112 may delete all information regarding a client system once the client system is certified. Portal 310 and/or server 112 may delete all the policy documents and responses, and keeping just the overall and component scores.

A client system 130 can interface with a client portal 330 for receipt of data, for example, documents 334 or via one or more forms 332. EPA security may be implemented using redaction of valuable or sensitive information. For example, an artificial intelligence tool may process data or documents submitted to a client portal 330 and reject or redact any data, submitted forms, or documents that contain valuable information, for example, information identifying the client providing the data to the client portal 330.

A risk management system 110 can implement a risk management system portal 310 for receipt of data, for example, encrypted forms 312 or encrypted documents 314. This data can be provided at a client portal 330 and sent by a client system 130 over a network 140 to risk management system portal 310.

Documents 334 can be encrypted on receipt at client portal 330. A user engaged with client portal 330 can submit an application, for example, containing one or more completed forms 332 or one or more documents 334, to risk management system 110 via risk management system portal 310. On submission of an application, the associated documents, forms, or data is copied to risk management system portal 310. Risk management system portal 310 is accessible behind one or more firewalls 320 or other security implementations. Risk management system portal 310 can further encrypt the data as encrypted forms 312 and/or encrypted documents 314.

Risk management system 110 can send one or more iterative requests for additional information from client system 130 and can approve the information received from client system 130 as being responsive to the request. An approval can permit a business operating or using risk management system 110 to start working with the client system 130 (and its related organization). This allows the business to send information and data to the client system 130 if needed. The approval can also trigger emails to the relationship manager to permit communication by the team with the client system 130. After approval, risk management system 110 can start monitoring the client system 130 and start notifying the client system 130 of specific security risks. Once approval is received by client system 130, the documents, forms, or data can be moved to risk management portal 310 and deleted from client portal 330. Deletion of the data from the client portal 330 helps ensure the level of valuable or sensitive information on a client system 130 or client portal 330 is controlled.

Risk management platform 100 can collect data about one or more client systems 130 through an online interface, for example, a client portal 330. Risk management platform 100 can securely transfer (e.g. encrypted) the data from an external cloud server to an internally hosted system and then permanently delete the data once ingested. The identity of a client system 130 can be masked by risk management platform 100 using a key, for example, a randomly generated number, as a unique identifier. The mapping of keys to identifiers can be held behind an internal firewall, for example, inside a risk management server 112 associated with a risk management system 110. This architecture can help ensure security of data from unauthorized access as client systems 130 or network connections to risk management system 110 can be more vulnerable to security threats or data interception than risk management system 110.

For example, in some embodiments, data sharing between a bank implementing risk management system portal 310 and a client portal 330 can be operable over a unique security layer that facilitates data sharing in a secure way. Upon receipt of information from a client portal 330, evaluation of the information, and certification of the client portal 330, the information is removed from the client portal 330 to avoid the existence of a copy of the information at the client portal 330.

The information can be assessed using artificial intelligence tools in view of one or more policies. The information can be processed using the one or more policies and a score can be generated. Artificial intelligence can be used to determine which policies are to be applied to what information. The client portal 330 can be accessed in a way to minimize exposure of valuable information, for example, identifying information, to unauthorized access or hackers of the client 330 or client portal 330. For example, two-factor authentication can be used so a client can engage with client portal 330 without providing an identifying client name. The client portal 330 can be used to access certification statistics, status, analytics, client profile information, or data.

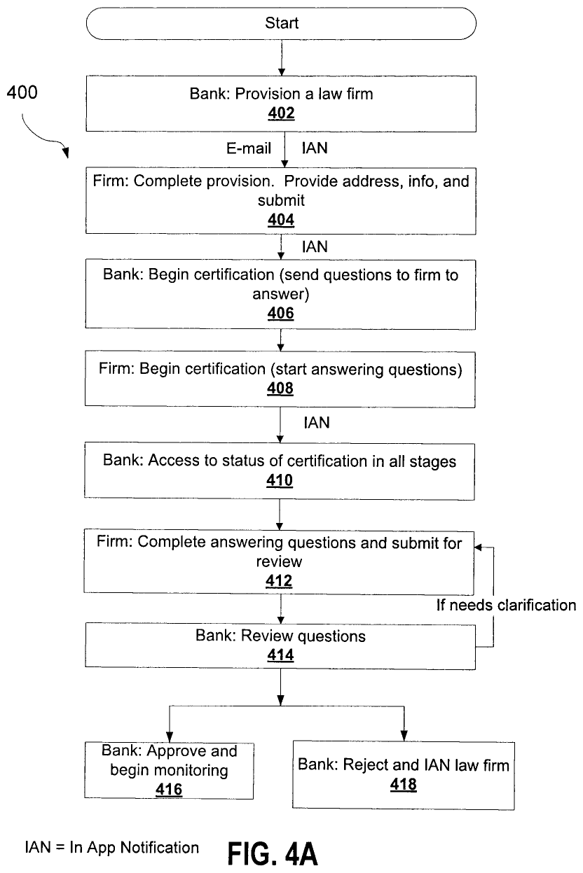

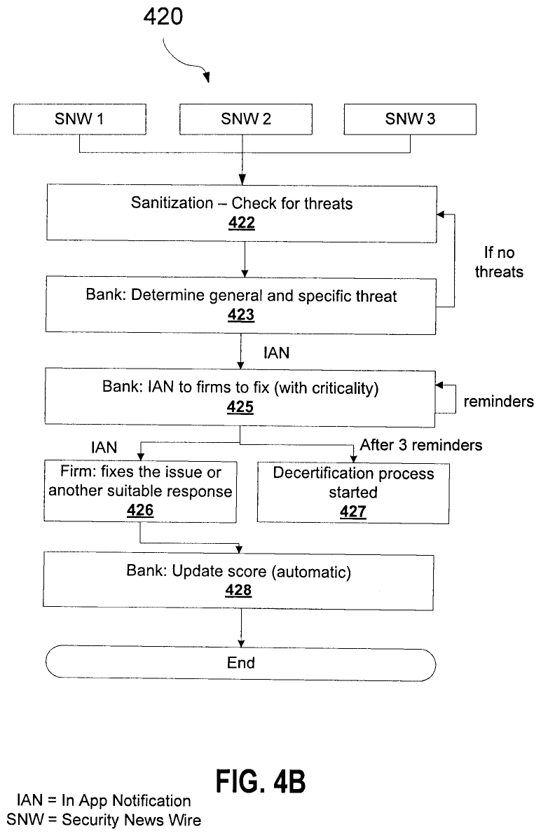

FIG. 4A is an example certification process 400 according to an example embodiment that involves a bank as a provider of risk management system 110 and a law firm as operator of client system 130.

At 402, risk management system 110 provisions a client system 130 via e-mail or an in-app notification (IAN) accessible via client portal 330 to start the assessment process. Risk management system 110 is operable to create a profile for a client system 130 to store data received or generated in relation to the assessment and ongoing monitoring of client system 130. The profile is linked to a unique identifier for client system 130. The unique identifier can be used by client system 130 to login with risk management system 110 and client portal 330. Risk management system 110 requests a set of data from client system 130 in order to perform an assessment for the certification process. For example, the requested data can include attributes of client system 130 and can identify computer hardware and software used by client system 130 along with information and data policies.

At 404, the client system 130 provides the requested data, for example, identifying information such as the unique token and other information, for example, in order to login. The client system 130 submits the data to the risk management system 110 using client portal 330. The risk management system 110 can implement a two factor authentication process for the login of client system 130, for example. This may be accompanied by an IAN. The IAN can log all notifications and requests at one place for audit purposes. Also, email notification could be disabled for security and efficiency and messages can be found at one place (in the app).

At 406, the risk management system 110 begins a certification process. For example, risk management system 110 selects one or more questions to populate a form of an interface accessible to the client system 130 via client portal 330. The questions may elicit security-related information that can be used by risk management system 110 to assess client system 130.

At 408, the client system 130 receives one or more questions and begins providing responses to the questions via client portal 330. Client portal 330 receives input data which is transmitted to risk management system portal 310. This may be accompanied by an IAN if there is a follow-up question or query, for example. Risk management system 110 continues to select questions for client system 130 based on attributes of the client system 130, previous responses by client system 130, historical data, and so on. The questions selected for client system 130 together create a dynamic set of questions.

At 410, the risk management system 110 accesses the responses provided via client portal 330 for evaluation and for selection of additional questions. Risk management system 110 can review the responses provided in order to determine the status of certification. The status of certification can indicate whether a complete set of data has been received from client system 130 in order for risk management system 110 to execute the certification process. For example, the status of a certification can be “incomplete” or “in progress” to indicate that the client system 130 has only responded to a portion of questions and only provided a subset of necessary data. As another example, the status of certification can be complete to indicate that the client system 130 has provided the set of data required for certification process. The certification status can be based on the responses provided so far, other data regarding computing hardware and software used by client system 130, and/or one or more scoring algorithms or instructions for computation used by scoring unit 230.

At 412, the client system 130 completes the responses to questions via client portal 330 and submits the information to the risk management system 110 for review and evaluation. In some embodiments, risk management system 110 does not use a static set of questions and instead uses a dynamic set by selecting additional questions in real time as part of the certification process and ongoing monitoring. The risk management system 110 dynamically presents questions to client system 130 via client portal 330.

At 414, the risk management system 110 reviews the information provided by the client system 130. If the risk management system 110 determines that the information requires clarification, then the risk management system 110 can continue to repeat 412 and 414 as needed. Risk management system 110 evaluates the responses to generate a certification status for the client system 130 using scoring unit 230 in order to determine whether sufficient data has been received to complete the certification process.

At 416, the risk management system 110 approves the information received by the client system 130 and generates a certification status for the client system 130. The risk management system 110 begins a monitoring process, for example, of security threats and corresponding security vulnerabilities in the client system 130. The risk management system 110 may continuously update the certification status based on the ongoing monitoring of client system 130. The certification process is continuous based on the monitoring. Alternatively, at 418, the risk management system 110 rejects the information received by the law firm's client system 130 and provides an IAN to the law firm regarding same. Approval can refer to certification of client system 130.

In some embodiments, after a client system 130 is certified, follow-up questions may be dynamically generated by AI unit 225 depending on specific assignments given to the firm associated with the client system. For example, if a firm engages with highly valuable information, the firm may be requested to answer follow-up questions regarding background checks, and the response may be factored into continued certifications, such that if the firm fails to provide a satisfactory response to one or more follow-up questions, it may be de-certified.

FIG. 4B is an example monitoring process 420 according to some embodiments.

At 422, a risk management system 110 receives information from one or more data feeds. In an example embodiment, the data feeds may be security news wires. This information can indicate or be used by risk management system 110 to identify one or more security threats relevant to one or more client systems 130. The risk management system 110 sanitizes the information and assesses the information for indication of security threats. A threat can be identified based on any combination of information from one or more security news wires, risk management systems 110, client systems 130, or databases, for example. For example, a first client system 130 may report a security threat to risk management system 110. The risk management system 110 can automatically determine that the security threat also applies to another client system 130. Accordingly, the risk management system 110 can generate an alert for the other client system 130 based on information received from the first client system 130.

In some embodiments, there may be two types of data feeds received by system 110: 1) structured data feed, which may be obtained from cyber security sources such as McAfee, Qualys, US Homeland Security; and 2) unstructured data feed: e.g. non-technical things that would apply to client systems. Unstructured data feed may include, for example, articles or news items that can be obtained by crawling the Internet. The articles or news items may not be directly related to cyber security, but still present one or more potential issues (e.g. data leak by a law firm located in the Caribbean region).

At 423, the risk management system 110 identifies general or specific threats relevant to one or more client systems from the information. Steps 422 and/or 423 may be repeated until a set of threats are identified. If a threat is identified, an IAN is generated for one or more client systems 130 that the threat is relevant to. Accordingly, the risk management system 110 identifies threats as being relevant to one or more client systems 130. As each client system 130 can involve a different collection of computer hardware and software a threat may be relevant to one client system 130 but not relevant to another client system 130. An IAN can contain information for multiple threats or there can be one IAN for each threat. An IAN message can specify a number of threats and guide the user to details of each threat. An IAN message can be one notification of one or more threats.

In some embodiments, a security threat may be determined for one or more client systems based on a type of products or components that the client system uses (e.g., a software application). For example, if the server 112 learns that a system in Panama was hacked because of a XYZ patch, it may automatically identify, based on existing security data, which firms may have the same or similar XYZ patch, and subsequently generates an alert for the identified firms.

In some embodiments, client systems may provide server 112 with a list of hardware, software and other technologies used or installed at the time of certification. Information risks obtained from various sources may be matched against these technologies and a risk level may be determined once a security threat is learned. A notification of risk with severity level may be sent within the system. The client systems that have received the alert can then choose to respond with a plan to remediate, status of remediation (e.g. confirmed action), or a counter-response indicating that the security threat does not apply to the client system.

At 425, the risk management system 110 sends an IAN to each of client system 130 that risk management system 110 has determined can be affected by the identified threat. The IAN can contain information about the identified threat, a patch, and/or directives on a solution. An IAN can provide instructions on how to fix the threat, mitigate the threat or provide information (such as a link) that may help dealing with the threat. The risk management system 110 can send multiple reminders to client system 130. The risk management system 110 continues to monitor client systems 130 that receive an alert to evaluate responsiveness of the client system 130. As described herein, the risk management system 110 can generate a score for a client system that can include a responsiveness score related to actions taken by client system 130 in response to receiving an alert.

At 426, the client system 130 fixes the issue in response to receiving an alert (or a reminder regarding the alert) from the risk management system 110. For example, the client system 130 can fix the issue by modifying a component of its computing system or associated system that satisfactorily responds to the threat identified in the IAN or that implements the directives contained in the IAN.

Alternatively, if the law firm 130 has not fixed the issue at a specified time after one or more reminders are sent to the client system 130, at 427, the risk management system 110 may begin a decertification process of the client system 130. This process results in association of the client system 130 with a decertification status and client management unit 250 can be updated to reflect same. The client system 130 can be notified as to the updated score. There can be configurations for the timing and a number of reminders before decertification begins. For example, there can be three reminders, the timing of that is adjustable according to the situation or policy.

In some embodiments, in order to for a client system to respond in a satisfactory manner, the client system may need to complete one or more action items, sometimes the list of action items may be dependent on the security threat. For example, a list of action items can include one or more of: network discovery, penetration test, vulnerability test, hardware refresh, hardware inventory and software inventory. Different client systems may be requested to complete different list of action items. In some embodiments, if a firm has completed one or more items in the list of action items, the firm does not need to complete the same item again. In some embodiments, if a firm has completed all of the required action items in a timely manner (e.g. within a prescribed time limit), the firm may be given a high score.

In some embodiments, a time extension may be granted to a client system that fits certain criteria. For example, if the client system is a class “C” firm (e.g. 10 staff or less), the client system may get a time extension to respond. Concurrently or alternatively, the client system may be requested to complete one less action item from the list of required action items.

At 428, the risk management system 110, via the risk management server 112, updates the score (e.g. through updating the responsiveness score component) associated with the client system 130 using scoring unit 230. For example, the responsive score component can be decreased or increased to a degree commensurate to the actions taken (or not taken) by the client system 130 to fix an issue related to the threat. For example, client system 130 may implement directives of a solution recommended by the risk management system 110. The responsive score can also factor the speed with which the client system 130 completed the actions to fix an issue related to the threat.

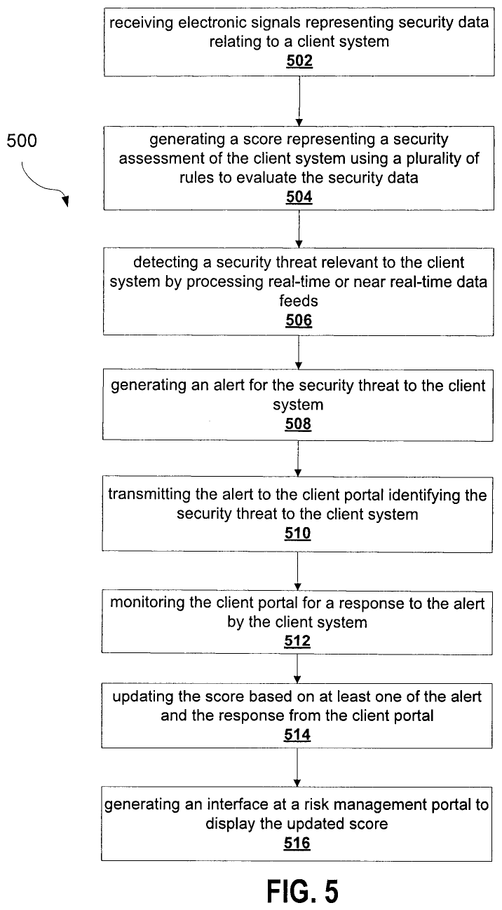

FIG. 5 is an example process 500 for assessing and updating a security score of a system according to some embodiments. At step 502, a computer processor of the risk management server 112 can receive electronic signals representing security data relating to a client system. At step 504, the computer processor can generate a score representing a security assessment of the client system using a plurality of rules to evaluate the security data. At step 506, the computer processor can generate a security threat relevant to the client system by processing real-time or near real-time data feeds. At step 508, the computer processor can generate an alert for the security threat to the client system. At step 510, the computer processor can transmit the alert to a client portal identifying the security threat to the client system. At step 512, the computer processor can monitor the client portal for a response to the alert by the client system. At step 514, the computer processor can update the score based on at least one of the alert and the response from the client portal. At step 516, which may be optional, the computer processor can dynamically update an interface at the client portal to display the score, the alert, and the updated score.

In some embodiments, risk management platform 100 can be used to evaluate information and system security of client systems 130, such as services providers or vendors, and can provide a process to manage same. For example, risk management platform 100 can be used by a financial institution to assess law firms or technology vendors from a suitability or matter workflow standpoint.

Risk management platform 100 can function as an overlay on top of an existing security system to provide a comprehensive and holistic evaluation of a vendor's information and system security. For example, risk management platform 100 can implement a security workflow solution tailored to law firms as information exchanged can be highly sensitive material such as legal advice. Entities using the risk management platform 100 can help manage business risk or liability in the event of a security threat or breach to their systems that arose from engagement with a service provider or vendor.

Cyberattacks and security threats constantly change on a daily basis. Risk management platform 100 can include an initial assessment of client system 130 and ongoing management and monitoring of the client system 130. Accordingly, risk management platform 100 implements an ongoing evaluation of information and system security given the changing and dynamic nature of security threats.

Risk management platform 100 may provide a more contextual assessment. For example, smaller law firms may be assessed for certification using a smaller set of questions than a larger law firm.

Risk management platform 100 can verify compliance with one or more security-related protocols or rules maintained by or monitored by risk management platform 100. Risk management platform 100 can verify actions taken by client systems 130 in responses to recommendations and threats, for example. In the event of a security-related attack, risk management platform 100 can provide an audit log to demonstrate that there were ongoing compliance checks for a client system 130. In the field of cybersecurity, there can be constantly changing applicable regulations, flagging of issues, or assessing or looking for corrections for the issues. Risk management platform 100 can use a dynamic set of questions to receive ongoing information from a client system 130 for assessment and monitoring.

Risk management platform 100 can gather assessment data that can enable the identification of which security threats can affect or target a particular client system 130 and provide ongoing monitoring of new security threats. Without this identification or ongoing monitoring, there can be unacceptable delays in addressing security vulnerabilities.

Risk management platform 100 can identify threats in real-time to help client systems 130 respond to threats and improve overall information and system security. Risk management platform 100 can indicate a classification of the threat, such as mild or severe, in order to help client system 130 prioritize actions in response to the threat.

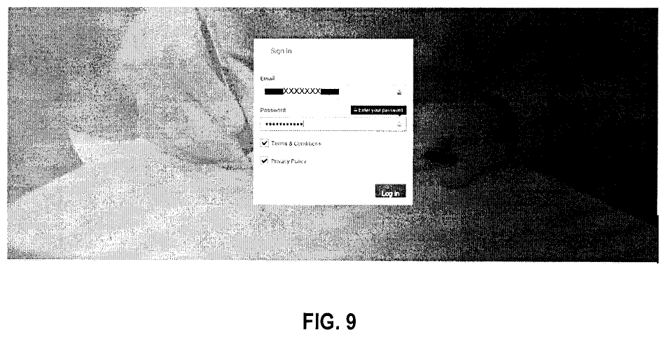

In some embodiments, risk management system portal 310 can provide a dashboard interface as part of an administrator portal 114. The risk management system portal 310 can populate the dashboard interface of the administrative portal 114 with alerts for security threats along with the classification of the security threats. An administrator portal 114 can be accessible via an interface with a login page as shown in FIG. 9, for example.

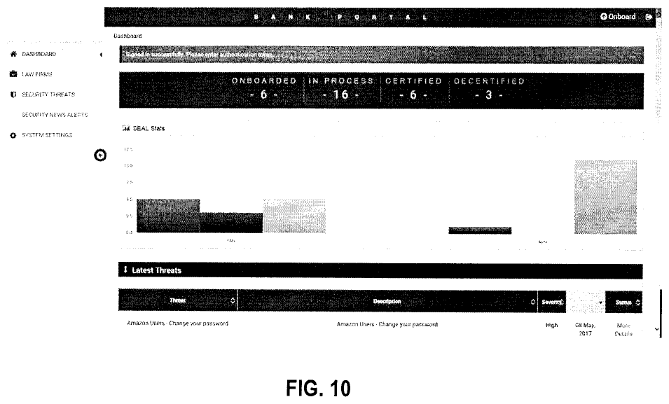

An example dashboard interface for an administrator portal 114 is shown in FIG. 10. The dashboard can include a statistics toolbar indicating the number of client systems 130 on boarded, in process, certified, or decertified. The example dashboard interface can include information relating to threats, severity or classification of threats, and statuses, for example. The example dashboard interface can also include a chart showing high-level analytics over time.

Security threats can be identified in different ways. For example, there can be input data from users that include identification of threats. As another example, risk management system 110 can employ an automated process of identifying threats by extracting data from real-time data sources (e.g. product vendors, government, newswires). Relevant security threats can be identified and ranked or classified by risk management system 110. For example, security threats identified from data from the Department of Homeland Security can be prioritized based on severity of the risk or impact.

Risk management system 110 can extract the relevant information from the data sources, onboard the information as a threat, collate the information with other data, and identify client systems 130 that may be impacted by threat. The information can also include solutions that may be implemented to address the threat. Risk management system 110 can generate an alert including the identified threat and solution and deliver the alert to client systems 130. For example, risk management system 110 can add an alert item as part of a threats window accessible via the dashboard interface provided by risk management system portal 310. In some embodiments, a client system 130 can set threat configurations to indicate threats that may be relevant it its computing systems. Risk management system 110 can use the threat configurations in order to generate alerts for the client system 130.

In some embodiments, an administrator engaged with administrator portal 114 can identify threats and solutions (e.g. create and publish patches), view active certifications in progress, monitor logins to client portals 330 (e.g. if a client has not logged in, this could signify a problem), view audit trails regarding security thresholds and score-related weightings for client systems 130 (e.g. audit trails can be used to track assessments), track manual intervention, download activity logs (e.g. as a PDF), or perform and manage administrative functions.

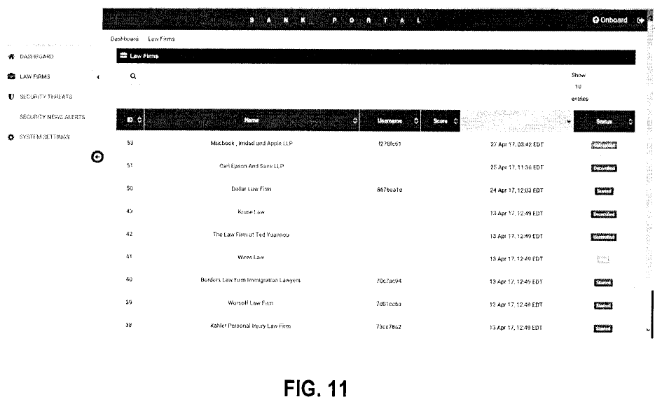

In some embodiments, as shown in FIG. 11, risk management system portal 310 can generate an interface as part of administrator portal 114 that indicates a list of client systems 130 (for example, law firms), their unique token or user name, their associated rank or score, and certification status. As noted, risk management system 110 can control a client portal 330 to present client system 130 with questions. Each answer or response can be associated with a score and risk management system 110 using scoring unit 230 can aggregate scores for a set of answers to the questions to generate an overall score. The overall score can be used to determine certification of the client system 130 by risk management system 110.

For example, the overall score can be based on a system score and to pass certification a minimum threshold system score must be met. The system score can have a weight such as for example 40% of the overall score. The overall score can be based on an assessor score that can be a discretionary score to enable an assessor to provide a contextual rating. The assessor score can have a weight such as for example 20% of the overall score. The overall score can be based on a responsive score that can provide an indication or measurement of response and action taken by a client system 130 in response to a threat alert, including time taken to respond. The responsive score can start high at the beginning of the certification process and decreases as the client system 130 does not respond. The responsive score can have a weight such as for example 40% of the overall score. The weights can be adjusted based on configuration parameters.

In some embodiments, an administrator engaged with administrator portal 114 can set up the score parameters to set up a flexible standard, filter search for a firm (e.g. all pending, all approved), understand risks while law firms are certified, obtain an inventory of law firm systems (e.g. servers, operating system, applications), view logs related to the feedback loop regarding threat notifications (if tagged as not relevant then this will update configurations), or prompt firms to update the data whether on an ad hoc or periodic basis.

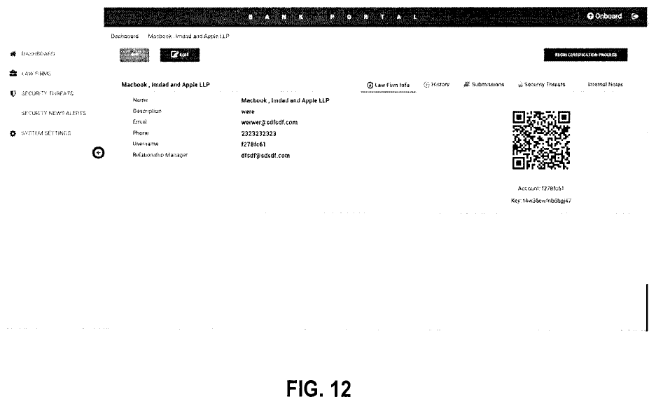

The administrator portal 114 can also include a window of information related to a specific client system 130, for example, as amalgamated or generated by client management unit 250. An example is shown in FIG. 12. Attributes relating to a client system 130 can include name, description, email, contact member, username, relationship manager, account identifier, machine-readable indicia, key or token, and so on. Additional attributes relating to a client system 130 can include historical data, submission data, security threat data, internal notes, and so on.

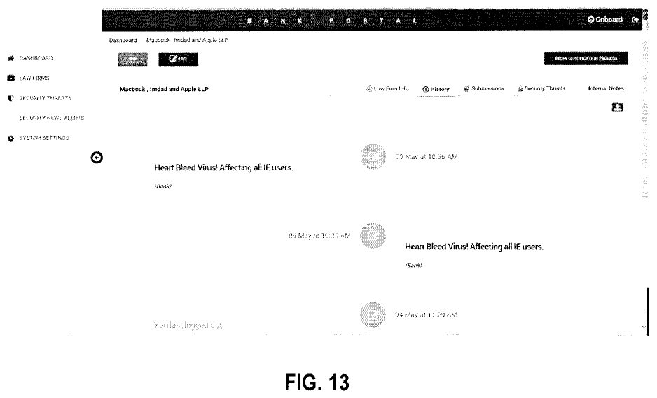

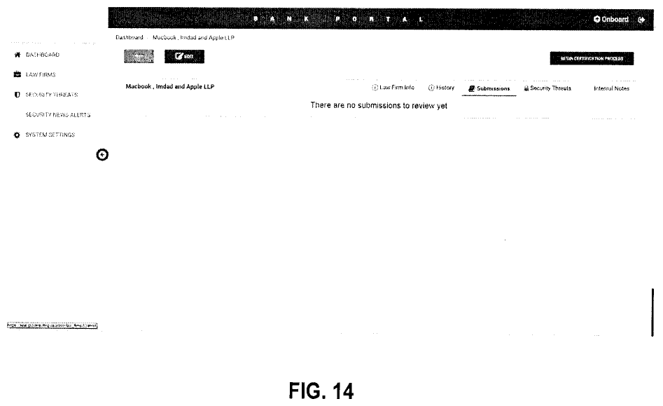

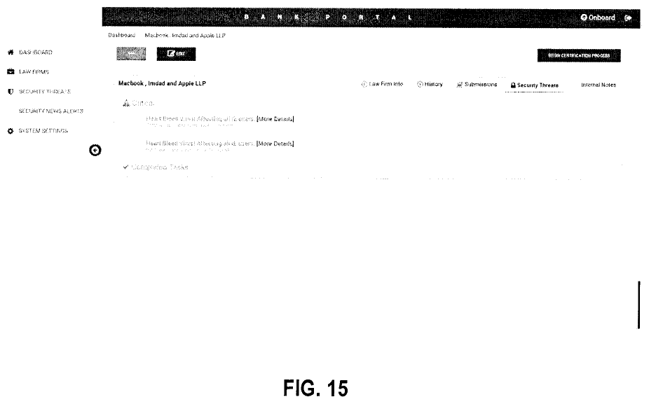

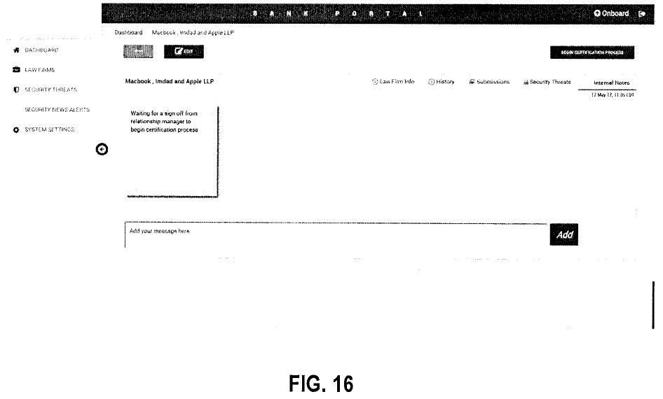

The administrator portal 114 can include a window of information with historical data specific to a client system 130, such as for example, information related security threats that are relevant to the client system 130. An example is shown in FIG. 13 with a timeline of alerts for threats that have been generated for the particular client system 130. The administrator portal 114 can also include submission information, for example, documents provided by the client system 130 via client portal 330. The submission information can be viewed via the interface of the administrator portal 114. An example is shown in FIG. 14. The administrator portal 114 can also include information for existing security threats that may affect the client system 130. An example is shown in FIG. 15. The example threat has an associated critical classification and also indicates the actions completed by client system 130 in response to an alert for the threat. An administrator can add, modify, or view internal notes or documentation via the interface of the administrator portal 114. An example is shown in FIG. 16.

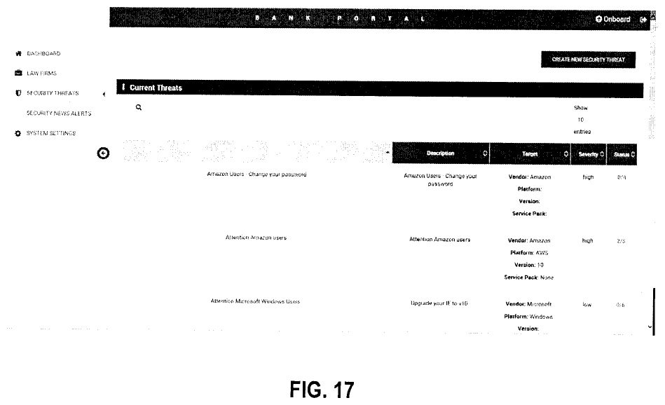

In some embodiments, the administrator portal 114 includes an interface to view, manage, or create security threats. An example is shown in FIG. 17. The interface lists current threats for particular computer software or hardware that can be used by client systems 130, along with a description of the threat, the targeted computer software or hardware, the severity of the threat, the status of actions taken in response to the alert for the threat (including reminders of the alert that have been sent), and so on.

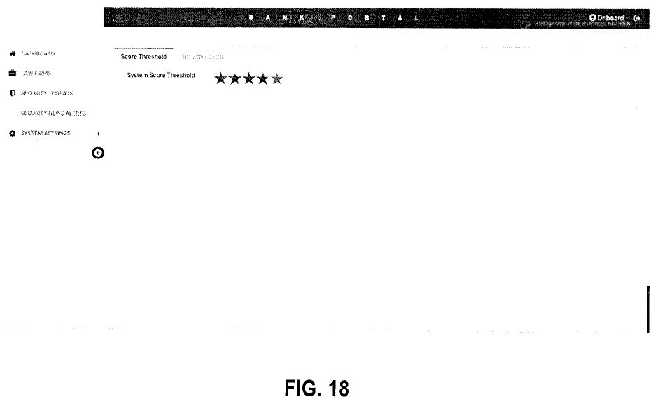

In some embodiments, the administrator portal 114 enables a user to adjust settings relating to thresholds against which scores are measured. An example interface is shown in FIG. 18 which indicates that a five-star rating or score is required in order to pass certification based on the system score.

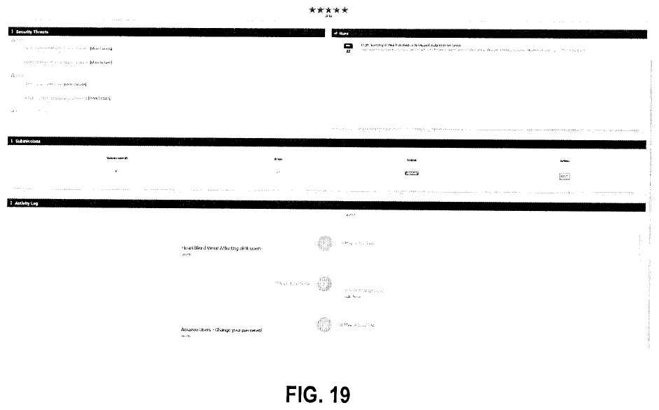

In some embodiments, a client portal 330 can be accessible via a webpage, for example, as shown in FIG. 19. For example, each law firm can be assigned a unique identifier that can be used to login to the webpage. If risk management system 110 re-certifies the client system 130, the client system 130 can maintain the same identifier. Risk management system 110 can collect and maintain a history of fails and re-tries at certification. The unique identifier de-identifies the client system 130 such that the identifier data cannot be used by a hacker to identify of the client system 130 in the context of security threats that may impact. Unauthorized access or interception of data can be further enabled by the de-identification (e.g. of name, address, etc.) of documents before upload by a client system 130 engaged with client portal 330.

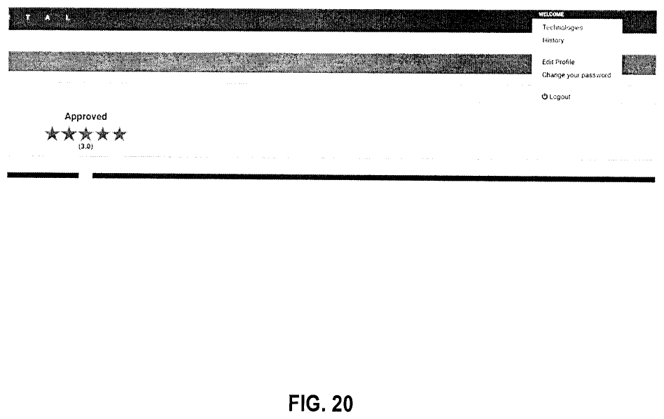

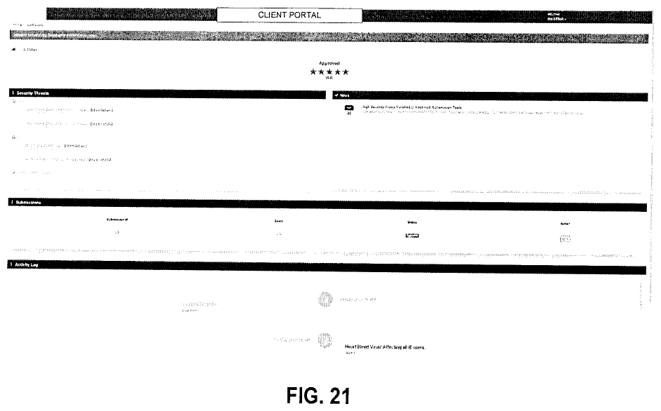

FIG. 20 shows a webpage used to access a client portal 330 where a logged in client system 130 can access the client portal 330 to view or modify various attributes, for example, profile information, login password information, technologies, history and so on. FIG. 21 shows a webpage used to access a client portal 330 so that a client system 130 can view information related to security threats that may affect its systems, news, its submissions, activity logs, and other information.

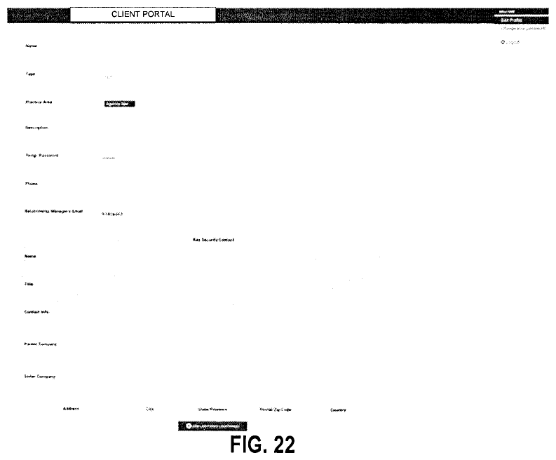

FIG. 22 shows an interface on client portal 330 with a form to receive, from a client system 130, profile information or attributes. Example attributes include name, type, practice, description, password, phone number, email, security contact, parent company, affiliated company, address information, and so on.

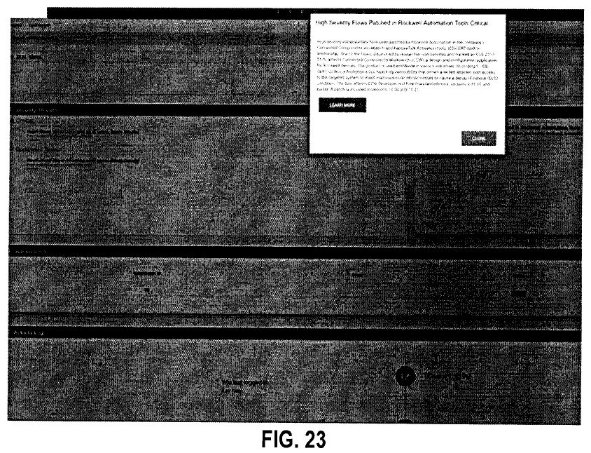

FIG. 23 is an example interface that shows details of a news item or alert related to patched security vulnerability and its associated threat. The alert can be viewed by client system 130 engaged with client portal 330.

In some embodiments, artificial intelligence tools can process policy documents provided by a client system 130 to a client portal 330. The risk management system 110 can automatically de-identify the information, for example, by redacting data that can be used to identify the client system 130 or source of the information.

In some embodiments, client portal 330 can include an interface with data such as a webpage profile or biographical details, historical audit information from a system perspective, statuses, expiration date for a certification or recertification, or submissions including questions and answers and policies. This information is available on the risk management system 110.

Risk management system 110 can implement a continuous certification process. The risk management system 110 can certify a particular client system 130 and that client system 130 has to continue particular actions to maintain certification. For example, the client system 130 should be active in the process and show responsiveness to security alerts propagated by risk management system 110. Continuous action can be required to maintain certification. The risk management system 110 provides a continuous certification by an initial assessment and ongoing monitoring of the client system 130.

Risk management system 110 can receive data, for example, via security news alerts. Risk management system 110 can process this information to identify threats specific to infrastructure of one or more client systems 130, including a classification of the severity of the threat. Risk management system 110 can automatically or allow manual association of a threat to a client system 130 or class of client systems 130. For example, via administrator portal 114, risk management system 110 can present a dynamic drop down list of client systems 130 such as vendors or law firms. Custom vendors can be added to the list and vendors can be shared with other law firms. Risk management system 110 can process custom vendor information before adding the data to the list as a single vendor may be identified differently. The list of vendors in the drop down list can be specific to the client systems 130 or general to all client systems 130.

Risk management system 110 can also store, maintain, and present information relating to each threat identified, for example, the threat's target or status (how many have fixed the problem). This data can feed into the responsive score automatically. If the score falls below the threshold then the client system 130 can lose its certification status. The responsive score can operate in the background looking for trigger events to move a score up or down and how much up or down. The characteristics of a client system 130 can impact how the score is updated. For example, a very large law firm might be slower to fix or respond to an alert given its size as compared to a small firm with only a few employees, therefore a fair weighting algorithm is needed. The responsiveness can be assessed in relation to actions taken in view of the solutions.

Risk management system 110 can gather data relating to what service the client system 130 provides to the administrator of risk management system 110 as it relates to the security risk/impact. Risk management system 110 can characterize the mandates or matters. For example, if the client system 130 classifies the work or service as “high risk” then there is a need to check that it is indeed high risk. The risk management system 110 can gather data relating to contextual factors about a client system 130, for example, size and nature of work.

Risk management system 110 can apply artificial intelligence to scoring and other aspects of risk management platform 100 such as threat management/prediction of the severity of the threats, data ingestion, document processing, and profile management (e.g. nature of the work, questions). The risk management system 110 can learn the behavior of the client system 130 as it relates to information and technology security to update its score.

A super user, for example, an administrator engaged with administrator portal 114, can manage system settings to change score thresholds, severity levels related to threats, and threats/notifications that are associated with actions. An example action can relate to a law firm that has to terminate a specific activity or to apply a patch.

In some embodiments, onboarding of a new client system 130 can involve the creation of a unique identifier and a key (for example, contained in a QR code) and a password, which are required for login.

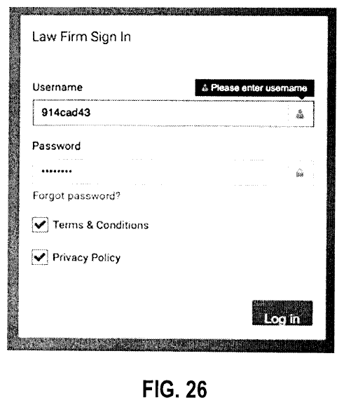

In some embodiments, client portal 330 can present a client system 130 with a login interface, as shown in FIG. 26. The client system 130 can login using a key or QR code using a security application installed on a smart device. In some embodiments, a client system 130 can classify work first and this is compared to a classification used by risk management system 110.

Risk management system 110 can assess a physical system structure of a client system 130. Risk management system 110 can implement a certification workflow based on a series of questions and answers. Risk management system 110 can dynamically present questions based on the type of client system 130, previous responses, or historical data, for example. In some embodiments, the questions are dynamically selected and presented. There may be no set of questions fixed from the outset. A question may exist in one or more different versions.

A threshold that an answer to a question can be measured against can change. Such change can cause a certification status associated with one or more client systems 130 to change. Decertification of a client system 130 may not be automatic. Rather, risk management system 110 can provide suggested actions for the client system 130 to maintain certification status.

A client system 130 engaged with client portal 330 can complete a form, for example, of questions, and then submit answers to the portal 330. In some embodiments, such data collection can be iterative and dynamic. For example, risk management system 110 can send follow-up questions based on previous answers received and/or data about the law firm, data about other client systems 130, or security data from security news wires. In some embodiments, an alternative to rejecting a law firm for certification can be sending additional follow-up questions. Risk management system 110 logs all data sent or received and all iterations of data elicitation.

This logged data can dynamically affect subsequent data elicited or subsequent questions presented to the client system 130. For example, if a client system 130 answers something the same way in the following year then risk management system 110 can cause client portal 330 to automatically present the follow-up question. Responses to the follow-up questions can be tagged as a specific note for the client system 130, for example.

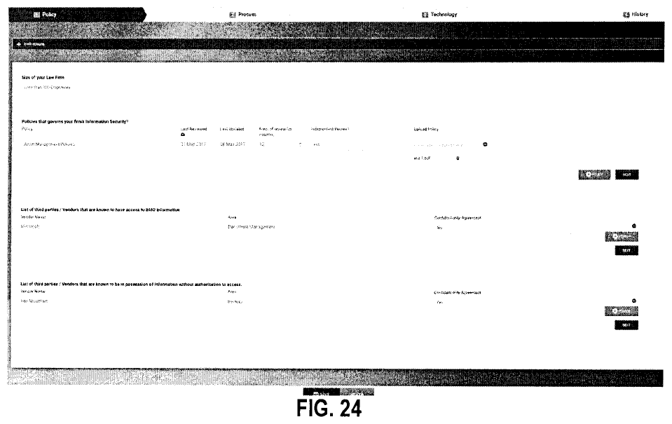

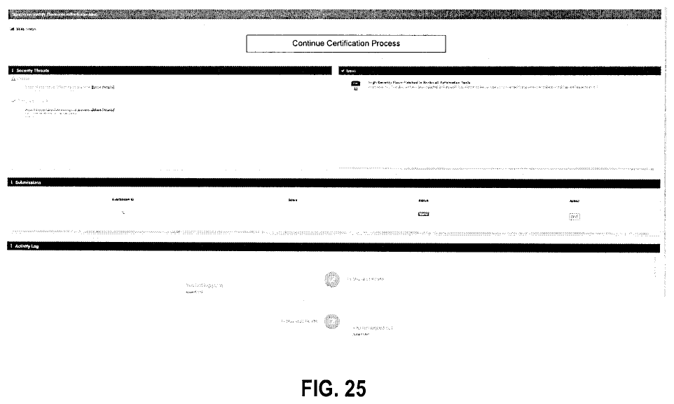

In some embodiments, a client system 130 can complete a profile (including practice areas, jurisdictions, locations) at client portal 330. An administrator (e.g. a bank) of risk management system 110 can receive notification of a completed profile and push out a certification of the law firm. The certification process for the client system 130 can be based on its security policies or processes, its technology/system, and historical data. The historical data and data relating to the technology or system can contribute to the system score component of the overall score for the client system 130. For example, FIG. 24 shows an example interface for client portal 330 where a client system 130 can provide this information. FIG. 25 shows an example interface for client portal 330 where a client system 130 can continue the certification process where additional information must be provided.

In some embodiments, the workflow concerning a policy provided by a client system 130 for security assessment by risk management system 110 involves the following steps: the client system 130 uploads the policy via client portal 330, client portal 330 pre-processes the policy to remove identifying information or other valuable information, client portal 330 encrypts the policy and transmits it to risk management system portal 310, and risk management system 110 assesses the policy. Subsequently, risk management platform 100 removes the policy from client portal 330 while the policy is stored securely in risk management system 110. The external firm site 330 can be on the other side of a firewall protecting risk management system 110. Data provided can be used to define targets that are matched to threats to generate alerts for a client system 130.

In some embodiments, the certification process by risk management system 110 is iterative. For example, risk management system 110 can flow certification down to client system 130 vendors. There can be a tiered structure of vendors that can also be certified by a risk management system 110 to increase the firm ranking. This may help manage security in a subcontractor ecosystem. Further, the certification status for a first company can be used to gain certification for another company. For example, if a party is certified under “cert 1” for a first company, then the party an get re-certified under “cert 2” for a second company by answering only a few additional questions instead of re-doing the entire certification process.

Risk management platform 100 can help ensure information security, including cybersecurity. Risk management platform 100 can look at detailed security processes for a law firm (e.g. does the system have ongoing penetration or vulnerability test) and can weight answers to select questions.

Client portal 330 can generate an interface with drop down selections of dynamically updated information (e.g. aggregate what other firms are doing), for example, security threats and solutions applied by other law firms. A law firm can add a customer vendor for select technology (e.g. Amazon v10). The dashboard interface can be automatically updated in real-time to show threats while a client system 130 is answering questions via client portal 330. Risk management system 110 can collect, aggregate, and identify optimal solutions for specific security threats based on solutions applied by client systems 130 and/or data provided by client systems 130. Risk management system 110 can update data feeds based on the feedback from a client system 130.

Risk management platform 100 can support P2P sharing of security information in an anonymized form so that client systems 130 are not exposed and can candidly reveal sensitive information about security vulnerabilities. Client systems 130 can be identified using a unique identifier that can only be used to reveal the identity of the client system 130 using a mapping that is securely stored in risk management server 112. In this way, sites external to risk management server 112 anonymously and securely manage data from client systems 130.

In some embodiments, the risk management server 112 is updated automatically and can generate follow-up questions and notes in real-time. This is updated in real-time on the external client portal 330. Follow-up questions can have individual statuses (e.g. resolved, outstanding).

Risk management system portal 310 can provide historical data. Historical data, for example, incidents of security threats or security information, can impact scores generated for a client system 130.

Risk management system 110 can provide security threat information in real-time as a law firm engaged with client portal 330 is completing a form.

Risk management system 110 can provide automatic recommendations to an assessor in real-time. These recommendations can guide the assessment or data collected by an assessor to generate an assessor score.

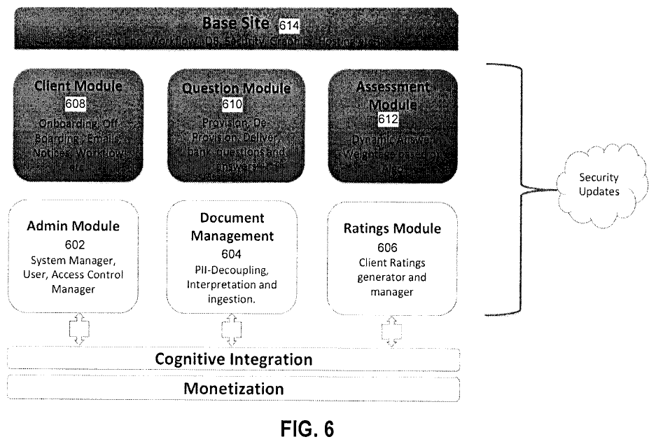

FIG. 6 is a view of an example architecture of risk management platform 100 according to some embodiments. Risk management platform 100 can include an administrator module 602, a document management unit 604, a ratings module 606, a client module 608, a question module 610, an assessment module 612, and a base site 614, each of which can be modified or updated by one or more security updates.

An administrator engaged with administrator portal 114 can access administrator module 602 to perform administrative functions or view reports or audit trails. Risk management system 110 via document management unit 604 can process, redact, amalgamate, interpret, or ingest data received from a client portal 330, for example, documents and forms. Document management unit 604 may use artificial intelligence algorithms to anonymize the data or classify the data.

The data can be elicited at a client portal 330 using one or more questions generated by question module 610 at risk management system 110 and transmitted to client portal 330. The questions generated or transmitted to client portal 330 can be dynamic, for example, based on previous answers to questions, answers to follow-up questions, historical data, security data received from security news wires, or data automatically collected. The data can include data automatically collected by risk management system 110 without user input via client portal 330. The data can include data provided by an assessor to risk management system 110, for example, via user portal 116 that provides back-end access to risk management system 110.

Assessment module 612 can dynamically assess, weight, and score answers to questions provided at a client portal 330. The assessment, weighting, and scoring can be based on one or more algorithms. The algorithms may be received by risk management system 110 via external server 120 over network 140 (or multiple networks) or may be as modified by an administrator or user engaged with administrator portal 114 or user portal 116.

Client module 608 can manage, collect, update, cause to be stored, associate, or amalgamate data related to a client system 130. For example, client module 608 can create profiles for client systems 130, create unique, anonymized identifiers for client systems 130, manage onboarding and off-boarding of client systems 130, and manage notices, alerts, and communication with client systems 130.

Base site 614 can manage the front end, workflow, databases, system security, graphics, and hosting. The base site 614 can be the framework for all the modules 602-608, for example.

Ratings module 606 can manage client ratings or score. Ratings module 606 can generate an overall score for a client system 130 using different metrics and weightings.

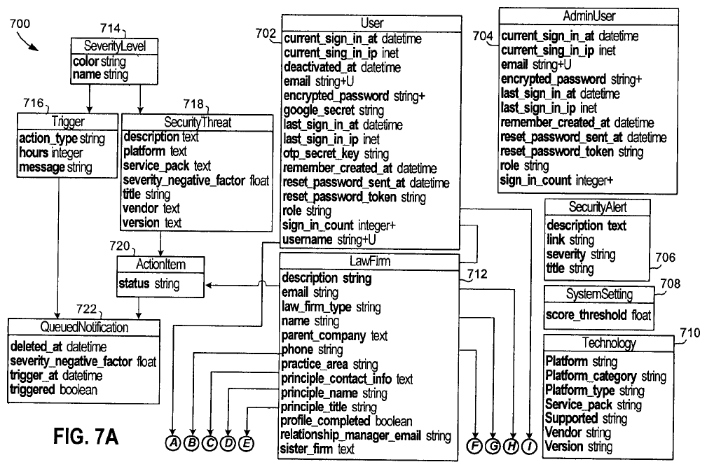

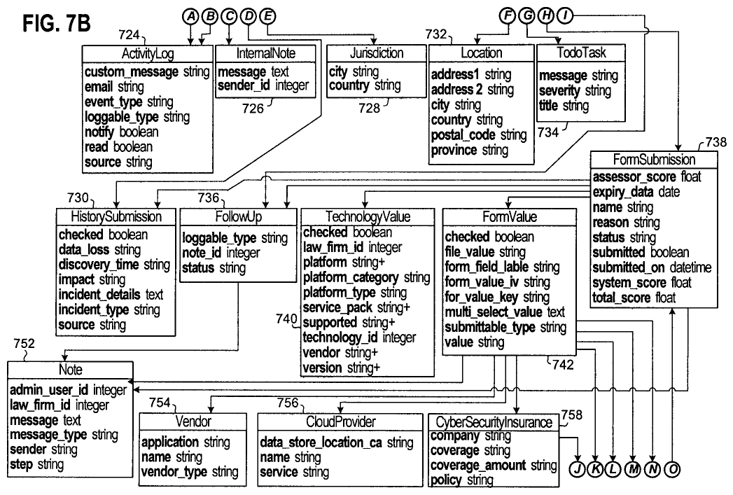

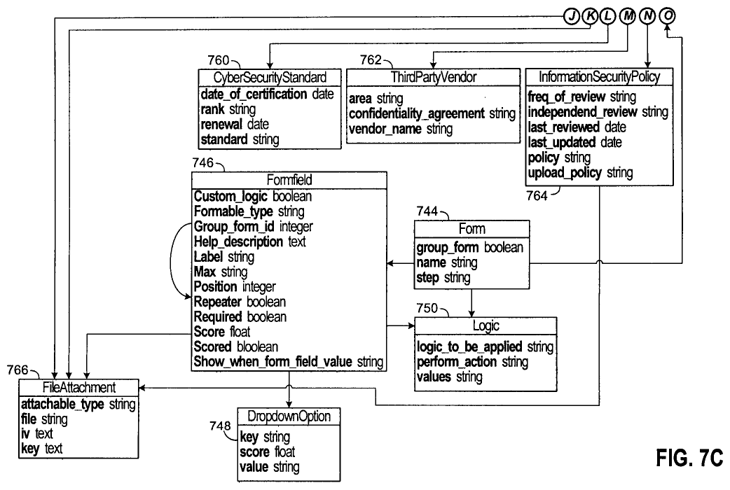

FIGS. 7A, 7B and 7C show a diagram of an example data model 700 that may facilitate referential integrity and functionality and can automate operation of risk management platform 100. Databases 260 can store data according to this database model 700. The database model 700 includes one or more database tables or data records. A table is a data structure that defines a set of data elements (values) and corresponding data types. A table is used to define the structure of different instances of data elements for different classes of data. A table can include data elements that link or reference a data element of another table to provide relational connections between tables. A table can include data elements that uniquely identify the instance of the table. The database model 700 can define data stored by the one or more databases 260.

The tables may include user table 702, admin user table 704, security alert table 706, system setting table 708, technology table 710, law firm table 712, severity level table 714, trigger table 716, security threat table 718, action item 720, queued notification 722, activity log table 724, internal note table 726, jurisdiction table 728, history submission table 730, location table 732, to do task table 734, follow up table 736, form submission table 738, technology value table 740, form value table 742, form table 744, form field table 746, drop down option table 748, logic table 750, note table 752, vendor table 754, cloud provider table 756, cybersecurity insurance table 758, cybersecurity standard table 760, third party vendor table 762, information security policy table 764, and file attachment table 766. The user table 702 may link to a relevant law firm table 712 which in turn may link to a relevant action item table 720, relevant activity log table 724, relevant internal note table 726, relevant jurisdiction table 728, relevant history submission table 730, relevant location table 732, relevant to do task table 734, and a relevant form submission table 738. The user table 702 may also link to a relevant activity log table 724 and a relevant follow up table 736.

The severity level table 714 may link to a relevant trigger table 716 and a relevant security threat table 718, which in turn may link to a relevant action item table 720. The trigger table 716 and the action item table 720 may each link to a relevant queued notification table 722.

The form submission table 738 may link to a relevant history submission table 730, relevant follow up table 736, relevant technology value table 740, relevant form value table 742, and relevant vendor table 762.

The form table 744 may link to a relevant form field table 746, relevant form submission table 738, and relevant logic table 750. The form field table 746 may in turn link to a relevant form value table 742, relevant file attachment table 766, relevant drop down option table 748, relevant logic table 750, and form field table 746.

Follow up table 736 may link to a relevant note table 752, for example.

Form value table 742 may link to a relevant vendor table 754, relevant cloud provider table 756, relevant cybersecurity insurance table 758, relevant cybersecurity standard table 760, relevant third party vendor table 762, relevant information security policy table 764, and relevant file attachment table 766.

Cybersecurity insurance table 758 and information security policy table 764 may each in turn link to a relevant file attachment table 766.

Each table may include one or more data elements or data fields to define attributes and store information and relationships. Different tables or data records may be linked by different keys or data values.

Each table can include data elements. Some data elements of a table can link to another table and instances thereof by way of identifiers.

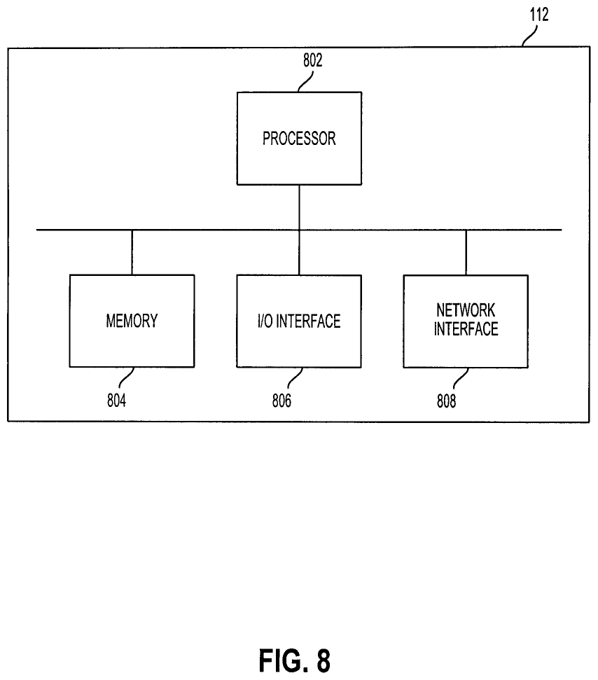

FIG. 8 is a schematic diagram of risk management server 112, exemplary of an embodiment. As depicted, risk management server 112 includes at least one processor 802, memory 804, at least one I/O interface 806, and at least one network interface 808.

Each processor 802 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 804 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 806 enables risk management server 112 to interconnect with one or more input devices, such as a keyboard, mouse, camera, touch screen and a microphone, or with one or more output devices such as a display screen and a speaker.

Each network interface 808 enables risk management server 112 to communicate with other components, to exchange data with other components, to access and connect to network resources, to serve applications, and perform other computing applications by connecting to a network (or multiple networks) capable of carrying data.

Risk management server 112 is operable to register and authenticate users (using a login, unique identifier, and password for example) prior to providing access to applications, a local network, network resources, other networks and network security devices. Risk management servers 112 may serve one user or multiple users.

The embodiments of the devices, systems and processes described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references may be made regarding control and computing devices. It should be appreciated that the use of such terms may represent one or more computing devices having at least one processor configured to execute software instructions stored on a computer readable tangible, non-transitory medium. For example, the platform 100 or risk management server 112 may have a server that includes one or more computers coupled to a web server, database server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product instructing physical operations. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the processes provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and processes implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The platform 100, risk management server 112 or client portal 330 may be implemented as a computing device with at least one processor, a data storage device (including volatile memory or non-volatile memory or other data storage elements or a combination thereof), and at least one communication interface. The computing device components may be connected in various ways including directly coupled, indirectly coupled via a network, and distributed over a wide geographic area and connected via a network (which may be referred to as “cloud computing”).

For example, and without limitation, the computing device may be a server, network appliance, microelectromechanical Systems (MEMS) or micro-size mechanical devices, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the processes described herein.

A processor may be, for example, a general-purpose microprocessor or microcontroller, a digital signal processing (DSP) processor, an integrated circuit, a field programmable gate array (FPGA), a reconfigurable processor, a programmable read-only memory (PROM), or any combination thereof.

Data storage device may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Computing device may include an I/O interface to enable computing device to interconnect with one or more input devices, such as a keyboard, mouse, camera, touch screen and a microphone, or with one or more output devices such as a display screen and a speaker.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, processes and steps described in the specification. As one of ordinary skill in the art will readily appreciate from the disclosure of the present invention, processes, machines, manufacture, compositions of matter, means, processes, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, processes, or steps.

As can be understood, the examples described above and illustrated are intended to be exemplary only. The scope is indicated by the appended claims.

1-68. (canceled)

69. A method comprising:
assigning, by a server, a unique token to each of a plurality of client system to anonymize an identification of each client system and storing a link between each unique token and a corresponding client system;
receiving, by the server, an electronic file uploaded from a client device of a client system and associated with the unique token of that client system;
generating, by the server, a unique key for the received electronic file;
storing, by the server in a data repository, the electronic file corresponding to the unique key;
deleting, by the server, identification data associated with the client system within the electronic file;
display, by the server, the electronic file without identification data;
generating, by the server, a score associated with the unique token and representing a security assessment of the client system based at least in part on the electronic file;
in response to a confirmation inputted to the server regarding the security assessment, deleting, by the server, the electronic file associated with the unique key within the data repository; and
continuously monitoring, by the server, each client system and when a security threat is detected,
sending, the server, an alert to each client system; and
updating, by the server, the score representing the security assessment.

70. The method of claim 69, further comprising:
displaying, by the server, a dashboard comprising updated score associated with each client system, wherein each score corresponds to the unique token of each respective client system.

71. The method of claim 69, further comprising:
identifying, by the server, a plurality of keywords within the electronic file;
for each keyword, determining, by the server, one or more parameters applicable to the keyword; and
generating, by the server, the updated score based at least in part on a value for each of the one or more parameters.

72. The method of claim 71, wherein the keyword corresponds to a password, and the one or more parameters applicable to the keyword comprise at least one of length, capital, letter, number, and character.

73. The method of claim 69, further comprising:
transmitting, by the server, an alert to the client system; and
updating, by the server, the score based on a response time to the alert from the client system.

74. The method of claim 73, wherein a response to the alert received from the client system indicates an action taken by the client system.

75. The method of claim 74, wherein the action comprises at least one of: network discovery, penetration test, vulnerability test, hardware update, and software update.

76. The method of claim 69, wherein the server deletes metadata associated with the electronic file.

77. The method of claim 69, wherein the server determines the score based on a response to one or more questions displayed on at least one electronic device of the client system.

78. The method of claim 69, wherein the server executes a machine learning model to analyze the electronic file and generate the score.

79. A computer system comprising:
a plurality of client systems connected to a server;
a data repository accessible to the server, wherein the server is configured to:
assign a unique token to each of a plurality of client system to anonymize an identification of each client system and storing a link between each unique token and a corresponding client system;
receive an electronic file uploaded from a client device of a client system and associated with the unique token of that client system;
generate a unique key for the received electronic file;
store, in a data repository, the electronic file corresponding to the unique key;
delete identification data associated with the client system within the electronic file;
display the electronic file without identification data;
generate a score associated with the unique token and representing a security assessment of the client system based at least in part on the electronic file;
in response to a confirmation inputted to the server regarding the security assessment, delete the electronic file associated with the unique key within the data repository; and
continuously monitor each client system and when a security threat is detected,
send an alert to each client system; and
update the score representing the security assessment.

80. The computer system of claim 79, wherein the server is further configured to:
display a dashboard comprising updated score associated with each client system, wherein each score corresponds to the unique token of each respective client system.

81. The computer system of claim 79, wherein the server is further configured to:
identify a plurality of keywords within the electronic file;
for each keyword, determine one or more parameters applicable to the keyword; and
generate the updated score based at least in part on a value for each of the one or more parameters.

82. The computer system of claim 81, wherein the keyword corresponds to a password, and the one or more parameters applicable to the keyword comprise at least one of length, capital, letter, number, and character.

83. The computer system of claim 79, wherein the server is further configured to:
transmit an alert to the client system; and
update the score based on a response time to the alert from the client system.

84. The computer system of claim 83, wherein a response to the alert received from the client system indicates an action taken by the client system.

85. The computer system of claim 84, wherein the action comprises at least one of: network discovery, penetration test, vulnerability test, hardware update, and software update.

86. The computer system of claim 79, wherein the server deletes metadata associated with the electronic file.

87. The computer system of claim 79, wherein the server determines the score based on a response to one or more questions displayed on at least one electronic device of the client system.

88. The computer system of claim 79, wherein the server executes a machine learning model to analyze the electronic file and generate the score.
